(19) United States
(12) Patent Application Publication
(10) Pub. No.: US 2005/0273383 A1
(43) Pub. Date: Dec. 8, 2005

(54) Business method for join advertisement of member stores using discount, thanks coupon & lottery ticket

(76) Inventor: Yong-Gyun Shin, Incheon (KR)

Correspondence Address: JONES DAY, 222 EAST 41ST ST, NEW YORK, NY, 10017, US

(21) Appl. No.: 10/529,138

(22) PCT Filed: Sep. 26, 2003
(86) PCT No.: PCT/KR03/01969

§ 371 Date: Mar. 23, 2005

(30) Foreign Application Priority Data
Sep. 26, 2002 (KR) 10-2002-0058360

(51) Int. Cl. G06F 17/60; A63F 9/24; A63F 13/00

(52) U.S. Cl. 705/14; 463/17

(57) ABSTRACT

Disclosed is a business method for join advertisement of member stores using advertisement materials such as discount/thanks coupons and lottery tickets, including the steps of: distributing the advertisement materials, made in a bundle by a publicity center of a central service provider managing the member stores, to each member store; distributing the advertisement materials to customers freely; the customer utilizing service recorded on the advertisement material with keeping the advertisement material; and determining a winning number of the advertisement materials and executing specific thanks event to a customer who possesses an advertisement materials having a winning number. Accordingly, this business method prevents duplicate and consumptive publicity by each member store and maximizes advertisement effects.

### TECHNICAL FIELD

The present invention relates to a business method for join advertisement of member stores using advertisement materials such as discount/thanks coupons and lottery tickets, and more particularly to a business method capable of increasing effect of join advertisement for business contents of each member store connected with a central service provider through a network system by using advertisement materials such as discount/thanks coupons and lottery tickets provided by the central service provider.

### BACKGROUND ART

Usually, service providers including a headquarter and member stores affiliated by franchise contracts provide customers with various free advertisement materials such as tissues, handy fans, stickers, candies, cigarette lighters, pads inserted under a notebook sheet, calendars, stationeries, and pamphlets. However, the effect of these conventional advertisement methods just induce transient interest of customers, and cannot maintain constant interest and transactional relationship. In spite of such problems, the business entities inevitably individually performs such less-economical advertisement activities repeatedly and periodically to achieve economical profits since there exists no alternative.

In brief, the conventional transient advertisements of individual business entities are substantially uneconomical in respect of time or cost. In addition, considering the trend of the industry where the chain business is more activated, a headquarter of the chain business performs total advertisement on behalf of its member stores, since the advertisement activity of individual member stores shows a limitation in attracting new member stores or activating business of the existing member stores. However, unless a concurrent advertisement system of member stores located in many places is developed, it is forecasted that activating the chain business is somewhat difficult.

To solve such problems related to the conventional business advertisement, there is a need for an alternative advertisement method which may conduct advertisement concurrently at various spots by the lead of headquarter so as to double the advertising effect. In addition, a new join advertisement system capable of overcoming place or time restriction by virtue of the developed telecommunication technologies is also demanded.

### DISCLOSURE OF INVENTION

The present invention is designed to overcome the aforementioned problems of the prior art. Therefore, an object of the present invention is to provide a new business method for maximizing advertisement effects by lead of a central service provider, and a business model for executing a join advertisement method and a thanks event for the advertisement using advertisement materials such as discount/thanks coupons and lottery tickets.

In order to accomplish the above object, the present invention provides a business method for implementing join advertisement of member stores using advertisement materials such as discount/thanks coupons and lottery tickets, which includes the steps of (a) distributing advertisement materials such as discount/thanks coupons and lottery tickets, made in a bundle by a publicity center of a central service provider managing the member stores, to each member store; (b) distributing the advertisement materials such as discount/thanks coupons and lottery tickets from the member stores to customers freely; (c) the customer, who receives the advertisement material, utilizing service recorded on the advertisement material with keeping the advertisement material until a lottery lot date; and (d) determining a winning number with respect to the lottery numbers recorded in the advertisement materials such as discount/thanks coupons and lottery tickets, and then executing a specific thanks event to a customer who possesses an advertisement material having a winning number.

At this time, it is preferable that the advertisement materials such as discount/thanks coupons and lottery tickets contain a specific lottery number, business contents and contact information of a plurality of member stores.

On the other hand, according to another aspect of the present invention, there is provided a system for implementing join advertisement of member stores using advertisement materials such as discount/thanks coupons and lottery tickets, which includes a lottery issuance system stored in a server of a central service provider connected to a terminal of each member store via a communication network for recording a lottery number in the advertisement materials. In this case, the lottery issuance system includes a lottery number issuance request receipt unit for automatically receiving a issuance request for the advertisement material from the terminal of the member store via the communication network, a random lottery number generation unit for generating a random lottery number whenever the lottery number issuance request is received, a lottery number transmission unit for storing the random lottery number in a lottery number database and transmitting the random lottery number to the terminal of the member store who requests the lottery number issuance, and a lottery winning verification unit for automatically confirming a winning result of the lottery number in the advertisement material.

At this time, the terminal of the member store is connected with a lottery number output unit for printing the lottery number received from the lottery number transmission unit on a blank area of the advertisement material. The system is configured so that, when the advertisement is delivered to a customer by the member store, the customer accesses the server of the central service provider through the terminal of the member stores or another network terminal and then checks a winning result using the lottery winning verification unit.

On the other hand, the advertisement system according to this embodiment may be operated in a different way. In other words, a telephone number system having a directory structure which may be automatically controlled by a central server of a communication service provider is built The telephone number system is transmitted to a data storage unit of a user terminal, and then telephone numbers of member stores are stored in a database having a directory structure in accordance with goods or service requested by the user.

When the user requests communication connection by accessing the database having directory structure stored in the user terminal or built in the central server of the communication service provider, the user terminal is automatically linked to a phone number of the member store terminal stored in the central server of the communication service provider. Therefore, it is possible to implement the join advertisement system in which a headquarter is capable of controlling total advertisement without individual advertisement by each member store.

In addition, the business method according to the present invention may be stored in the computer readable recording media. These recording media include all kinds of recording media storing program and data to be read by computer system such as Read Only Memory, Random Access Memory, CD (Compact Disk)-Rom, DVD (Digital Video Disk)-Rom, Magnetic tape, Floppy Disk, and Optical data storage equipment. Moreover, the recording media may be implemented in the form of carrier wave (e.g. transmission via the Internet). Moreover, such recording media are distributed on computer system connected through a network, and then computer readable code may be stored and processed by a distributed processing method.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic diagram showing a system for implementing a business method for join advertisement of member stores using advertisement material such as discount/thanks coupons and lottery tickets according to one preferred embodiment of the present invention; and

FIG. 2 is a schematic diagram showing a system for implementing a business method for join advertisement according to another preferred embodiment of the present invention.

### BEST MODES FOR CARRYING OUT THE INVENTION

Hereinafter, preferred embodiments of the present invention will be described in detail with reference to the accompanying drawings. However, it will be evident that various modifications and changes may be made to the embodiments according to the present invention. Accordingly, embodiments to be described below should be regarded just as an illustrative one rather than a restrictive sense. Other embodiments will be apparent to those of ordinary skill in the art in light of this disclosure.

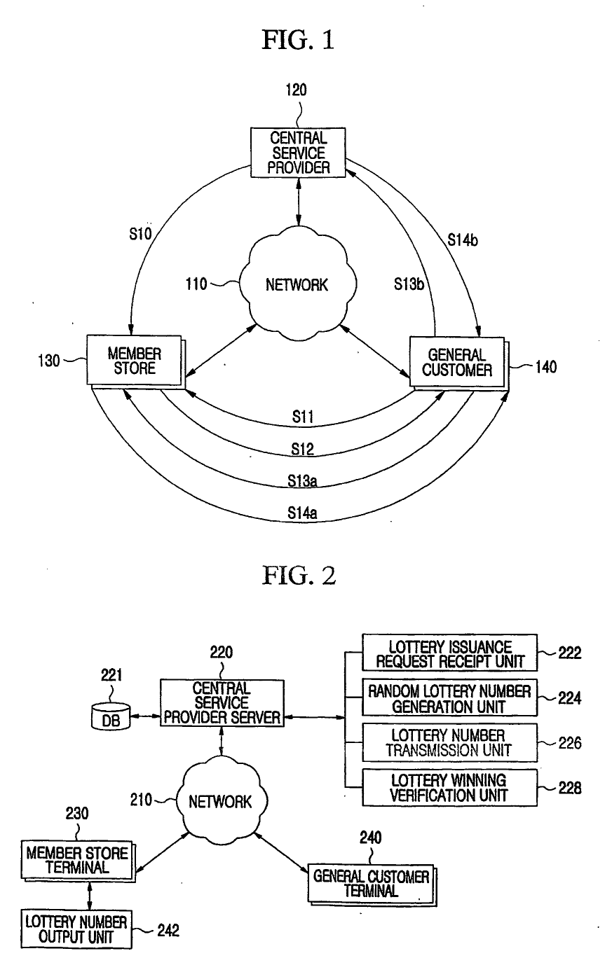

FIG. 1 is a schematic diagram showing a system for implementing a business method for join advertisement of member stores using advertisement material such as discount/thanks coupons and lottery tickets according to one preferred embodiment of the present invention.

FIG. 1 shows a procedure of a thanks event using advertisement materials such as discount/thanks coupons and lottery tickets issued for promoting interest of general customers 140 on the business of a central service provider 120 and member stores 130. Here, the central service provider 120 is connected with the member stores 130 via a network 110 for the purpose of interactive business relationship and advertisement.

Initially, the central service provider 120 issues and distributes the advertisement materials such as discount/thanks coupons and lottery tickets to the member stores 130, and then the member store 130 distributes the advertisement materials containing business advertisement contents to existing and potential customer 140 freely.

Costs for material and human resources required for producing and distributing the advertisement materials such as discount/thanks coupons and lottery tickets are reasonably divided between the central service provider and the member stores according to a predetermined contract. However, it is preferable to distribute the advertisement materials to the customer freely.

The advertisement material such as discount/thanks coupons and lottery tickets may contain only business information including business contents, telephone numbers of business entities, and so on. However, the advertisement material may be preferably divided into two sections: an advertisement contents section for advertising business contents of the business entity to general customers, and a lottery number section for recording a lottery number.

Moreover, the advertisement materials such as discount/thanks coupons and lottery tickets are not restricted in their shape and material. However, it is desirable that the advertisement materials are not easily damaged due to its frequent use, on the consideration of a long term till the lot date of the lottery ticket. In addition, it is also desirable that shape and material of the advertisement materials are similar to conventional ones in order to prevent customers from feeling awkward. However, such matters depend on the selection of business entities, and advertisement effect may also be sufficiently filled by recording advertisement contents and lottery number on necessities of life. Furthermore, the advertisement material may also be made in a sticker type so that it may be easily adhered to and detached from any object.

Particularly, the join advertisement system according to present invention is useful for a business system such as a franchise business which is capable of directly extending total advertisement effects of a central service provider to member stores. Moreover, if the system of the present invention is combined with a business system capable of processing entire orders by a key telephone system used recently and providing goods or service through a member store near a customer, the effects of advertisement may be more increased.

Hereinafter, the advertisement process of the business method according to the present invention conducted through the network 110 will be described in detail with reference to FIG. 1. The central service provider 120 makes and firstly distributes predetermined advertisement materials such as discount/thanks coupons and lottery tickets to the member stores 130 (S10). Each member store 130 then distributes the advertisement materials to the general customers 140 who visit the member store 130 (S11) in accordance with the usage or object of advertisement (S12). At this time, the distribution method may be applied not only to the general customers 140 who visit the member store 130, but also a manager or clerk of the member store 130 may meet and provide the general customer 140 with the advertisement materials (not shown). If the advertisement materials such as discount/thanks coupons and lottery tickets are distributed to the general customer 140, the general customer 140 checks a winning result for the lottery number recorded in the advertisement material at the member store 130 or from the central service provider 120 after a lottery lot date expires (S13a and S13b). Next, the member store 130 or the central service provider 120 confirms the winning result and executes a predetermined thanks event to a bearer of the advertisement material containing the winning number (S14a and S14b).

FIG. 2 is a schematic diagram showing a system for implementing a business method according to another preferred embodiment of the present invention.

As can be seen from FIG. 2, in a join advertisement system for the business method of this embodiment using advertisement materials such as discount/thanks coupons and lottery tickets, a central service provider server 220, member store terminals 230 and general customer terminals 240 are connected through a communication network 210. The central service provider server 220 includes a mass storage database 221 for storing information to be issued and winning results of the advertisement materials as well as information related to the member stores or the general customers. Specially, in the join advertisement system, the central service provider server 220 includes a lottery issuance request receipt unit 222, a random lottery number generation unit 224, a lottery number transmission unit 226, and a lottery winning verification unit 228. In addition, the member store terminal 230 is connected with a lottery number output unit 242.

In order to distribute the advertisement material to the general customer, it is required to print a lottery number on a blank area of the advertisement material. Thus, when a request for issuance of an advertisement material having a lottery number is input from the member store terminal 230, the lottery issuance request receipt unit 222 plays a role of receiving the request.

Upon receiving the request for lottery number issuance, the random lottery number generation unit 224 generates random numbers, and then selects and endows random numbers as a lottery number if the random numbers are not coincident with any issued lottery number. Next the lottery number transmission unit 226 stores the generated random lottery number in a lottery number database, and transmits the random lottery number to a terminal of the member store who requests the lottery number issuance. In addition, when advertisement materials such as discount/thanks coupons and lottery tickets issued by the lottery number output unit are delivered to the general customers by the member store, the general customers contact a server of the central service provider through the customer terminal 240 or the member store terminal 230. And then, if the customer asks for checking whether the lottery number in the distributed advertisement material wins a prize, the lottery winning verification unit 228 automatically determines whether the lottery number wins a prize and then transmits the winning result.

On the other hand, the member store terminal 230 is connected with the lottery number output unit 242 for recording the lottery number received from the lottery number transmission unit 226 in the advertisement material such as discount/thanks coupons and lottery tickets.

The advertisement system may be used for indirectly verifying effects of the advertisement activity using the advertisement materials such as discount/thanks coupons and lottery tickets in real time. In addition, since the lottery number is generated randomly, it is possible to prevent a customer from bothering clerks or managers of the member store to change a lottery number as he/she wants. However, it is also possible to allow a customer to select a lottery number as desires.

On the other hand, the advertisement system according to this embodiment may be operated in a different way. In other words, a telephone number system having a directory structure which may be automatically controlled by a central server of a communication service provider may be built The telephone number system is transmitted to a data storage unit of a user terminal, and then telephone numbers of member stores are stored in the data storage unit having a directory structure in accordance with goods or service requested by the user.

When the user requests communication connection by accessing the database having the directory structure stored in the user terminal or built in the central server of the communication service provider, the user terminal is automatically linked to a phone number of the member store terminal stored in the central server of the communication service provider. Therefore, it is possible to implement the join advertisement system in which a headquarter is capable of controlling total advertisement without individual advertisement by each member store.

### INDUSTRIAL APPLICABILITY

According to the present invention, it is possible for a central service provider to conduct total advertisement without inefficient advertisement procedure by each member store. In case of a chain business adapting a key telephone number system, the central service provider may process requests of customers collectively so that the member stores just provide goods or service to customers. In addition, when a customer orders specific goods or service, it is also possible that the present invention is additionally provided with a system for automatically switching a call to a member store near the customer.

In brief, the business method according to the present invention may maximize advertisement effects by inducing general customers' interest to the advertisement materials. Particularly, it is efficient to increase the number of customers by freely distributing the advertisement materials such as discount/thanks coupons and lottery tickets.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A business method for join advertisement of member stores using advertisement materials such as discount/thanks coupons and lottery tickets, the business method comprising the steps of:
(a) distributing advertisement materials such as discount/thanks coupons and lottery tickets, made in a bundle by a publicity center of a central service provider managing the member stores, to each member store;
(b) distributing the advertisement materials such as discount/thanks coupons and lottery tickets from the member stores to customers freely;
(c) the customer, who receives the advertisement material, utilizing service recorded on the advertisement material with keeping the advertisement material until a lottery lot date; and
(d) determining a winning number with respect to the lottery numbers recorded in the advertisement materials such as discount/thanks coupons and lottery tickets, and then executing a specific thanks event to a customer who possesses an advertisement material having a winning number.

2. The business method according to claim 1, wherein the advertisement materials such as discount/thanks coupons and lottery tickets contain a specific lottery number, business contents and contact information of a plurality of member stores.

3. A system for implementing join advertisement of member stores using advertisement materials such as discount/thanks coupons and lottery tickets, which includes a server of a central service provider connected to a terminal of each member store via a communication network and having a lottery issuance system for printing a lottery number in the advertisement materials, wherein the advertisement materials issued by the lottery issuance system are distributed to customers at each member store, wherein the lottery issuance system comprises:
a lottery number issuance request receipt unit for automatically receiving a issuance request for the advertisement material from the terminal of the member store via the communication network;
a random lottery number generation unit for generating a random lottery number whenever the lottery number issuance request is received;
a lottery number transmission unit for storing the random lottery number in a lottery number database and transmitting the random lottery number to the terminal of the member store who requests the lottery number issuance; and
a lottery winning verification unit for automatically confirming a winning result of the lottery number in the advertisement material,
wherein the terminal of the member store is connected with a lottery number output unit for printing the lottery number received from the lottery number transmission unit on a blank area of the advertisement material,
wherein the system is configured so that, when the advertisement is delivered to a customer by the member store, the customer accesses the server of the central service provider through the terminal of the member stores or another network terminal and then checks a winning result using the lottery winning verification unit.

4. A business method for join advertisement of member stores using advertisement materials such as discount/thanks coupons and lottery tickets, the business method comprising the steps of:
building a telephone number system having a directory structure which may be automatically controlled by a central server of a communication service provider;
transmitting the telephone number system to a data storage unit of a user terminal;
storing telephone numbers of member stores in a database having a directory structure in accordance with goods or service requested by the user; and
when the user requests communication connection by accessing the database having directory structure stored in the user terminal or built in the central server of the communication service provider, linking the user terminal to a phone number of the member store terminal stored in the central server of the communication service provider,
whereby a headquarter can control total advertisement without individual advertisement by each member store.
